(19) United States
(12) Patent Application Publication
(10) Pub. No.: US 2008/0149825 A1
(43) Pub. Date: Jun. 26, 2008

(54) APPARATUS FOR MASS ANALYSIS OF IONS

(75) Inventors: Viatcheslav Ivanovich KOZLOVSKI, Moskau (RU); Katrin FUHRER, Gunten (CH); Marc GONIN, Gunten (CH)

Correspondence Address: MATTHEW R. JENKINS, ESQ., 2310 FAR HILLS BUILDING, DAYTON, OH, 45419, US

(73) Assignee: TOFWERK AG, Thun (CH)

(21) Appl. No.: 11/953,442

(22) Filed: Dec. 10, 2007

(30) Foreign Application Priority Data
Dec. 14, 2006 (EP) 06 405 519.7

(51) Int. Cl. B01D 59/44

(52) U.S. Cl. 250/287

(57) ABSTRACT

An apparatus for mass analysis of ions comprises a high current ion source, in particular an ion source providing at least 5 million ions/s, preferably at least 50 million ions/s, at an output of the ion source, a time-of-flight mass spectrometer for analysis of ions transmitted from the ion source and a filter for segmenting incoming ions according to their m/q ratio into a first group of ions and into a second group of ions. The filter is coupled to the ion source and the filter and the time-of-flight mass spectrometer are arranged in such a way that the ions of the first group are transmitted to the mass spectrometer and that the ions of the second group are not transmitted to the mass spectrometer. Furthermore, the filter is designed in such a way that the second group consists of ions belonging to one or several narrow bands of m/q. The apparatus allows for analyzing minor compound ions generated by the high current ion source with good selectivity, undisturbed by major compounds.

### BACKGROUND OF THE INVENTION

1. Field of the Invention

The invention relates to an apparatus for mass analysis of ions comprising a high current ion source, a time-of-flight mass spectrometer for analysis of transmitted ions and a filter for segmenting incoming ions according to their m/q ratio into a first group of ions and into a second group of ions, whereas the mass filter is coupled to the ion source and whereas the mass filter and the time-of-flight mass spectrometer are arranged in such a way that the ions of the first group are transmitted to the mass spectrometer and that the ions of the second group are not transmitted to the mass spectrometer. The invention further relates to an arrangement for mass analysis of particles as well as to methods for mass analysis of ions and particles.

2. Description of the Related Art

Mass spectrometry is a method of analysis that can be applied in a wide field of different applications. Especially time-of-flight mass spectrometers (TOFMS) can be used for chemical and biological analysis in many different fields, including the analysis of gases, liquids, solids, plasmas, aerosols, biological aerosols, biological material, tissue, and so forth.

In a TOFMS all compounds of a sample are analyzed simultaneously. While this feature leads to very short analysis times, it has the drawback that major compounds of a sample may saturate the TOFMS system and disturb the analysis of minor compounds, especially if high current ion sources providing 5 million ions/s or more, or even 50 million ions/s or more are used. Because TOFMS do not work in a filter mode like other MS, that analyze only one species after the other, but accept the whole mass range of species simultaneously, the saturation effects observed with high current ion sources in TOFMS are very different from other MS. Typical high current ion sources where severe saturation effects in TOFMS are observed include high emission current electron impact ion sources, inductively coupled plasma ion sources, glow discharge ion sources, chemical reaction ion sources, and beam sputtering ion sources where ions are generated with a primary ion beam or a photon beam, chemical ion sources.

Saturation in TOFMS can occur for many different reasons: saturation of the detection electronics, saturation of the ion detector, saturation caused by stray ions and peak tails etc. Saturation in the TOFMS detection electronics occurs when in a single TOF extraction the number of ions arriving at a certain time-of-flight is higher than, the detection capacity of the data acquisition (DAQ) electronics. Time-to-digital DAC electronics, for example, allow for measuring one ion in a time window where the certain ion specie arrives. This means that a TDC is experiencing saturation effects as soon as the ion rate on anyone specie approaches 1 ion/extraction. An 8-bit ADC, in contrast, is able to detect several ions/extraction. 8 bits transform to a theoretical maximum of 255 ions/extraction. In reality the maximum ion flux is about 2 to 4 times lower. This means that the dynamic range per time is about 100 times higher for ADC systems then for TDC systems. Therefore, TOFMS analysis with high ion flux and therefore risk of saturation effects preferably use ADC DAQ systems. By operating two ADC channels in parallel or by using logarithmic preamplifiers or logarithmic attenuators the ion flux can be further improved. Therefore, TDC systems usually saturate at an ion flux of roughly 10,000 to 1 Mio ions/s, whereas ADC systems may saturate at 4 to 40 times higher ion flux rates.

Ion detectors consist of a two stage process: ion to electron conversion and electron multiplication. Electron multipliers have a maximum ion count rate which can lead to saturation. In case of multi channel plate electron multipliers which are often used in TOFMS, the maximum ion flux is between 1 and 50 Mio ions/s, depending on MCP type and size. Dynode detectors can support 10 times higher ion rates.

TOFMS systems are known to have considerable tails on the spectrometric peaks. For very abundant species these tails can extend over a large miss range and increase the background by several orders of magnitude on neighboring species. Often the background is elevated over the whole spectrum. These tails can limit the detection limit of certain species, especially if there are very abundant species close to the specie of interest. Thereby, intensive species can impose a high limit of detection on minor species. This effect can also be considered a saturation effect.

To give an example for saturation, the analysis of semi conductor dopants by TOFMS may be difficult because dopant compounds may be swamped by Si (being the major compound of the sample) or by the primary ion used for sputtering the sample from the semi conductor. Similarly, saturation is a problem when trace species are analyzed, where the so called matrix produces an overwhelming amount of ions which are not of interest. Examples are the analysis of trace gases in air where N₂, O₂, and Ar ions (and their fragment ions) are produced in large quantities and may saturate the mass spectrometry system. In plasma ion sources the plasma gas often constitutes a major specie that can cause the saturation effects mentioned above.

To date there are three known ways to control various aspects of saturation in a mass spectrometer with a high current ion source.

A first approach of overcoming this problem is the use of selective ionization. A method of ionization is used that does not ionize the major compounds. Thereby, the minor compounds that are ionized are no longer covered by abundant species. The problem with this approach is that for some samples it may be difficult to find a method of ionization with appropriate selectivity. Furthermore, in state-of-the-art selective ionization processes usually primary ions are created that subsequently transfer charge to secondary ions to be ionized. However, the vast majority of primary ions reach the detector and may themselves lead to saturation problems. A drawback of a selective method in combination with time-of-flight is also that the method looses its broad-band capability.

A second approach is the integration of m/q filters, so called ion gates into the mass analyzer. Such ion gates can eliminate certain species of ions by eliminating certain masses or ranges of masses. Such gates (mass filters) may be part of the mass analyzer. In time-of-flight mass spectrometers these ion gates exploit the fact that at a given location on the flight path and at a given time the ions of different masses are already sufficiently separated in time, such that specific ranges of m/q can be eliminated from the normal flight path by switching the gate between open and closed (see Hoffmann E., Lüdke Ch, The ICP TOF mass spectrometer: an alternative for elemental analysis, Spectroscopy Europe, Int. J. Mass Spec and Ion Proc., 17, 1 (2005) 16-23). The drawback of this method lies in the increased background species due to scattered ions originating from the abundant species.

A third technique is described in U.S. Pat. No. 6,140,638 (Tanner et al.). Filters are used in combination with reaction chambers where charge transfer reactions are used to transfer a dominating ion compound to a lower or higher mass ion, and a low mass cut-off or band pass filter transmit only a mass range above a certain mass or a mass window with both low mass and high mass cut off. The drawback of this method is that the reaction has to be tailored to one specific species and is not applicable to a wide range of ions.

Furthermore, various mass filters are used for different purposes:

One technique is called tandem mass spectrometry or MS/MS (see Belov US 2004/183007 and Bateman 2001/052569). In MS/MS the filter is used to isolate a single precursor ion which is dissociated in a following process in order to get structural information from fragment ions. These filters are typically implemented before the inlet of the MS. These filters are band pass filters and therefore traditional RF quadrupoles are used.

In another technique filters are used to remove certain species to be able to relate reaction products to its precursor; namely a filter is applied in a collision induced dissociation cell to selectively remove reaction products, which allows to distinguish between primary and secondary, reaction products (see Watson Th. J, D. Jabuen, H. Mestdagh, Ch. Rolando, A technique for mass selective ion rejection in a quadrupole reaction chamber, Int J. Mass Spec and Ion Proc., 93 (1989) 225-335).

A further approach is described in U.S. Pat. No. 6,627,912 B2 (MDS Inc.): Within a collision cell a field is provided that discriminates against interfering ions (polyatomic ions, un-specific fragment ions, collision products etc.) based on their lower kinetic energy. The field is chosen such that it provides significantly greater retardation to these interfering ions such that these ions are preferentially lost. The purpose of the filter is to minimize isobaric interferences from ions which are not of interest.

### SUMMARY OF THE INVENTION

We propose a new method to overcome the saturation problems of a high, current ion source combined with a time-of-flight mass spectrometer, which does not suffer from the drawbacks of the three methods listed above. It is the object of the invention to create an apparatus for mass analysis pertaining to the technical field initially mentioned, that allows for analyzing minor compound ions generated by a high, current ion source with good selectivity, largely undisturbed from major compounds.

The solution of the invention is specified by the features of claim 1. According to the invention the (mass or more precisely m/q) filter is designed in such a way that the second group consists of ions belonging to one or several narrow bands of m/q. This allows for avoiding saturation effects even in cases where the ion source as well as the time-of-flight mass spectrometer are constituted and operated in such a way that the flux of ions generated by the ion source causes saturation effects in the time-of-flight mass spectrometer when the ion source is directly coupled to the time-of-flight mass spectrometer.

In particular, narrow bands of m/q relate to Δ(m/q)=1 or 2 Th, i.e. preferably only a single species or two species of neighboring (m/q) are filtered out, i.e. at least partially not transmitted to the mass spectrometer. Filtering out or substantially reducing non-desirable major species prior to the TOFMS avoids saturation of the system. At the same time, scattered ions within the TOFMS originating from the abundant species are impeded. In contrast to prior art band filters (such as in MS/MS applications), due to the narrow range, all the desirable species may be transmitted through the mass filter to the TOFMS, i.e. the broad-band capability of the analysis apparatus is preserved. Consequently, all the desired minor species may be detected by a detector and/or processed by a data acquisition system with good selectivity, undisturbed from any major compound ions. The inventive combination of a high current ion source, a filter and a time-of-flight mass spectrometer therefore allows for taking precise broad-band measurements with good statistics, unhindered by saturation problems.

In particular, in the context of the invention plasma ion sources may be used, where usually the most abundant ions are representing the plasma gas and therefore are not of interest. For example, an argon plasma ion source typically produces a large amount of Ar⁺ and Ar⁺⁺ ions which may saturate the mass spectrometer unless a filter as described in this invention is used.

The invention can be used in all mass spectrometric measurements where a high dynamic range is needed or where major and minor components are present and minor components are of interest. Examples are: elimination of carrier gas ions in GC-MS measurements, elimination of semi conductor ions in dopant analysis, elimination, of primary beam ions in beam sputtering ion sources, elimination of the primary ions of a selective ionization ion source, elimination of ions from main atmosphere gas in trace gas analysis, elimination of electrons, elimination of ions of abundant material in bio analysis and chemical analysis.

Accordingly, a method for mass analysis of ions using in particular an ion source as well as a time-of-flight mass spectrometer that are constituted and operated in such a way that a flux of ions generated by the ion source would cause saturation effects in the time-of-flight mass spectrometer if the ion source were directly coupled to the time-of-flight mass spectrometer, comprises the steps of:

a) segmenting incoming ions according to their m/q ratio into a first group of ions and into a second group of ions;

b) transmitting the ions of the first group to a time-of-flight mass spectrometer and discarding the ions of the second group; whereas

c) the incoming ions are segmented in such a way that the second group of ions consists of ions belonging to one or several narrow bands of m/q.

In particular, the time-of-flight mass spectrometer comprises an ADC ion detection system. As mentioned above, ADC detectors allow for measuring comparably large ion fluxes. In the context of the inventive combination of a high current ion source-selective (mass) filter and TOF mass spectrometer, an ADC ion detection system allows for taking precise measurements even if the output of the ion source is a very large ion flux.

Preferably, the filter comprises a field generating device which is designed in such a way that it generates a primary confining RF field capable of transmitting ions towards the time-of-flight mass spectrometer as well as one or several RF fields superimposed with the primary field. The RF frequencies of these fields match oscillation frequencies of ions belonging to the one or several narrow bands of m/q. The incoming ions are injected into the primary confining field transmitting the ions towards the time-of-flight mass spectrometer. Ions belonging to the narrow bands of m/q are resonantly excited and finally ejected from a confining area of the primary field. Accordingly, only the desired ions that do not belong to the narrow bands of m/q reach the time-of-flight mass spectrometer coupled to the mass filter.

The selectivity of filtering can be adjusted by changing parameters of the excitation RF fields. Several additional excitation RF fields can be applied simultaneously in order to eliminate several species or several m/q ranges. Furthermore, excitation RF amplitudes may be increased in order to eliminate wider m/q ranges.

Alternatively, if the ion species to be filtered out is of a lower mass than all the interesting species being generated by the ion source, a low m/q cut-off of a suitable primary confining field is used to eliminate the corresponding low m/q range of ions.

Advantageously, the primary confining field is a RF multipole field, in particular a RF-only-quadrupole field. In principle the primary confining field may also consist of a superposition of multipole fields. It is known that an oscillatory inhomogeneous electrical field forms a so-called effective potential which is proportional to E², where E is the amplitude of the electrical field strength oscillations (see e.g. Landau L. D., Lifshitz E. M.: Mechanics, Pergamon Press, Oxford 1976; Gerlich, D. “Inhomogeneous Electrical Radio Frequency Fields: A Versatile Tool for the Study of Processes with Slow Ions” in: State-Selected and State-to-State Ion-Molecule Reaction Dynamics, edited by C. Y. Ng and M. Baer. Advances in Chemical Physics Series, LXXXII, 1, 1992). In case of a quadrupolar RF electrical field the effective potential results in a net force on the ion towards the quadrupole axis. This force is inverse proportional to the ion mass-to-charge ratio (m/q) and directly proportional to the ion distance from the quadrupole axis. This fundamental property of the effective potential results in that an ion with a given m/q will perform slow oscillations around the quadrupole axis with a characteristic frequency which is inversely proportional to its m/q, i.e. the quadrupole field is a confining field suitable for the mass filter according to the invention. Alternatively, a field comprising higher multipole components is employed and/or at the entrance and the exit of the filter additional RF fields are used to shape the ion beam.

Linear RF multipole fields that are particularly well adapted for the inventive filter are usually produced using co-axial rods of parabolic or circular shape. Other shapes may be used e.g. in order to approximate quadrupole fields. A primary RF-only field is applied between sets of opposing rods. Furthermore, one or several additional small amplitude RF fields are superimposed to the primary RF field. The frequencies of the additional fields must be adjusted to the characteristic oscillation frequencies of the ions to be eliminated in the primary RF field. The ions with the corresponding m/q will be gradually resonantly excited by the low amplitude RF fields and finally be ejected from the primary RF-multipole field and therefore eliminated from entering the following mass analyzer. The excitation is preferably carried out in high vacuum (no collisions of ions with residual gas), but can also be carried out in gas filled RF quadrupoles at intermediate pressures up to 10 mbar. Ions with different m/q and therefore different characteristic frequencies will not be ejected.

In another preferred embodiment, the RF-multipole field is a 2-dimensional quadrupole field trapping the ions in an area surrounding their main path towards the time-of-flight mass spectrometer. This allows for a particularly simple field geometry and reduced complexity of the field electrodes, the RF generating components and the control logic.

The above mentioned RF quadrupole field may be super-positioned by further RF quadrupole fields and/or by higher multipole fields. Higher multipoles (such as octupoles) allow for steeper ascending fields; however excitation of the ions is complicated. Therefore, it may be advantageous to combine a main quadrupole RF field with higher multipole fields having smaller amplitudes in order to shape the RF field. Alternative to 2-dimensional fields 3D quadrupole or multipole fields may be used, forming substantially closed regions trapping the supplied ions. After switching off or altering the trapping field the ions may be withdrawn from the trap.

In a preferred embodiment the field generating device is capable of generating a rotating quadrupole field. In principle, such devices are known and have previously been used for fundamental kinetic studies (see V. V. Raznikov, I. V. Soulimenkov, V. I. Koziovski, A. R. Pikhtelev, M. O. Raznikova, Th. Horvath, A. A. Kholomeev, Z. Zhou, H. Wollnik, A. F. Dodonov; Ion rotating motion in a gas-filled radio-frequency quadrupole ion guide as a new technique for structural and kinetic investigations of ions; Rapid Communications in Mass Spectrometry; Volume 15, Issue 20, Pages 1912-1921). However, in the context of the present invention by employing such a field the resolution of the elimination window may be further improved. Furthermore, employing a rotating quadrupole field allows for carrying out the inventive method using higher multipole fields.

The field generating device may further generate an essentially coaxial linear field superimposed to the primary RF field in order to transport the incoming ions an axis of the primary field, towards the time-of-flight mass spectrometer, i.e. the ions are axially dragged through the quadrupole field. This embodiment is mainly useful if the residual gas pressure within the mass filter is high and ions loose their axial velocity because of collisions with residual gas particles. In cases of low gas pressure and high initial ion velocities the coaxial linear field may be dispensed with. There are various methods to realize the superposition of such an ion transporting field known to people skilled in the art. Segmented quadrupoles with an RF voltage divider along the segments is the most well known version.

The field generating device may be designed in such a way that different superimposed RF frequencies may be alternately generated such that several narrows bands of m/q are scanned and ions belonging to these bands are resonantly excited and ejected from the confining area of the primary field. This allows for easily eliminating wider m/q ranges or several specific m/q species without having to simultaneously generate several RF frequencies and without the problem of interference between different frequencies.

The field generating device may also be designed in such a way that superimposed RF frequencies may be generated that are pulsed (i.e. alternately switched on and off) with a selectable pulse-width; i.e. the mass filter is alternately switched from a gating to a non-gating mode. This way, an ion number of at least one of the narrow bands of m/q in order may be selectively reduced or different mass spectra may be subsequently analyzed by the time-of-flight mass spectrometer. The sensitivity of the mass spectrometer can be synchronized with the pulsed mode by e.g. adjusting the detector gain to avoid saturation in the non-gating mode. This allows the recording of major and minor species and for recording high dynamic range mass spectra.

Alternatively or additionally, excitation amplitudes may be adjusted in order to only reduce but not completely eliminate a certain species

The apparatus may comprise a device for cooling the ions to be inserted into the mass filter, the device being designed in such a way that it generates a confining multipole field capable of transmitting ions towards the mass filter and that it holds a gaseous atmosphere filling a confining region of the multipole field. For example, the device for cooling comprises a RF quadrupole ion guide that is operated at elevated pressure (0.1-1000 Pa; preferably 1-100 Pa) of a gas such as He, N₂, air etc. Preferably, the same gas is used as in the high current ion source. Cooling creates an ideal ion phase space to allow for a compact and high resolution mass elimination filter having an optimum filtering efficiency. The device for cooling facilitates the transition of the produced ions from the high pressure ion source to the low pressure mass filter/analyzer.

Another preferred embodiment comprises a selective ion source for selectively ionizing particles to be analyzed, followed by the inventive mass filter and time-of-flight mass spectrometer. In principle, selective ion sources allow for very sensitive mass measurements. However, as explained above, if charge exchange reactions are employed (e.g. in so called chemical ionization sources), excess primary ions (or other non-analyte ions involved in the ionization process) may lead to saturation problems within the mass analyzer. Employing the mass filter of the invention, these excess primary ions may be selectively filtered out from entering the TOFMS. Therefore, a combination of a selective ion source with the mass filter according to the invention allows for obtaining precise results without having the problem of saturation.

Within the inventive method, the ions may be stored in a confining multipole field, and the RF ejection frequencies are applied during part or a total of a storage time of the ions. Therefore, the primary RF confining field is used as a storage field. The mass filter is e.g. operated in a storage mode by setting exit and entrance plates to appropriate voltages to increase residence time of the ions. This way, ion ejection efficiency and resolving power of rejection of non-desirable ions may be increased.

Alternatively, there is no storage mode of the mass filter and the mass filter is designed and operated such that the ions from the ion source that are not to be ejected transit the mass filter substantially once, from the input to the output.

In a preferred embodiment the ions of above mentioned second group are not completely ejected but the ions of the second group are suppressed by a factor pₗ, i.e. a small portion p of the ions are transferred into the TOF, i.e. the filter is operated as a selective ion suppressor. Useful values of pₗ, are e.g. 10⁻⁵ to 0.1. This is achieved by appropriately tuning the parameters of the filter, e.g. by appropriately adjusting the amplitude of excitation RF fields and/or by employing pulsed superimposed RF frequencies and by adjusting the pulse ratio. This means that the filter is not operated at the maximum suppression of the filter for the given ions but at a suppression that is considerably lower, particularly at least a factor of 10 lower. Preferably, the suppression factor is chosen in such a way that the ion flux is just lowered below the saturation limit e.g. that the ion flux is within a range of 1/10 of the saturation limit and the saturation limit. This allows for obtaining a large number of measurements even of the suppressed species while simultaneously avoiding the saturation problems.

In order to determine the suppression factor pₗ the method includes a calibration step, during which the factor pₗ is evaluated in order to analyze quantitatively a yield of ions in the second group, i.e. the transmitted portion p for each filtered specie. This allows then to also quantify the abundant species by dividing their measured (suppressed) yield by the suppression factor p. The calibration procedure usually includes the measurement of an ion specie with and without the filter under non-saturated conditions by using, for example, lower ion flux, different DAQ systems, different ion detectors or even different mass specs. The suppression factor can then be calculated as the ratio of the ion flux with filter on and the ion flux with the filter off. Another method of calibration includes the simultaneous measurement of the filtered specie and another specie where the original abundance ratio of the two species is known. Isotopic species can be used for this because their ratios are usually well known. From the measured ion flux ratio and the known abundance ratio the suppression factor can be calculated.

In a preferred embodiment the TOFMS DAQ automatically identifies in real time intensive species that potentially cause saturation effects mentioned above. Based on this information the filter is adjusted according to the m/q and intensity of these species.

If the sample composition is approximately known in advance, it is possible to have predetermined filter setting schedules optimized for the sample. Filter settings are then changed based on analysis time to new settings in the schedule.

The two approaches above can be combined by using filter schedules and using real time data information for triggering new predefined filter settings from the schedule.

Other advantageous embodiments and combinations of features come out from the detailed description below and the totality of the claims.

### BRIEF DESCRIPTION OF THE DRAWINGS

The drawings used to explain the embodiments show:

FIG. 1 is a schematic representation of a first inventive apparatus for mass analysis of ions;

FIG. 2 is a schematic representation of an RF-only quadrupole ion guide;

FIGS. 3A and 3B are examples of the effect of the inventive mass filtering on a mass spectrum obtained using a downstream TOFMS;

FIG. 4 is a schematic representation of a second inventive apparatus for mass analysis of ions comprising a selective ion source;

FIGS. 5A and 5B are schematic examples of the effect of the inventive mass filtering on a mass spectrum created by the selective ion source;

FIG. 6 is a schematic representation of a third inventive apparatus for mass analysis of ions comprising a device for cooling the ions to be inserted into the mass filter; and

FIG. 7 is an example of a mass spectrum recorded with and without the filter.

In the figures, the same components are given the same reference symbols.

### DESCRIPTION OF THE PREFERRED EMBODIMENTS

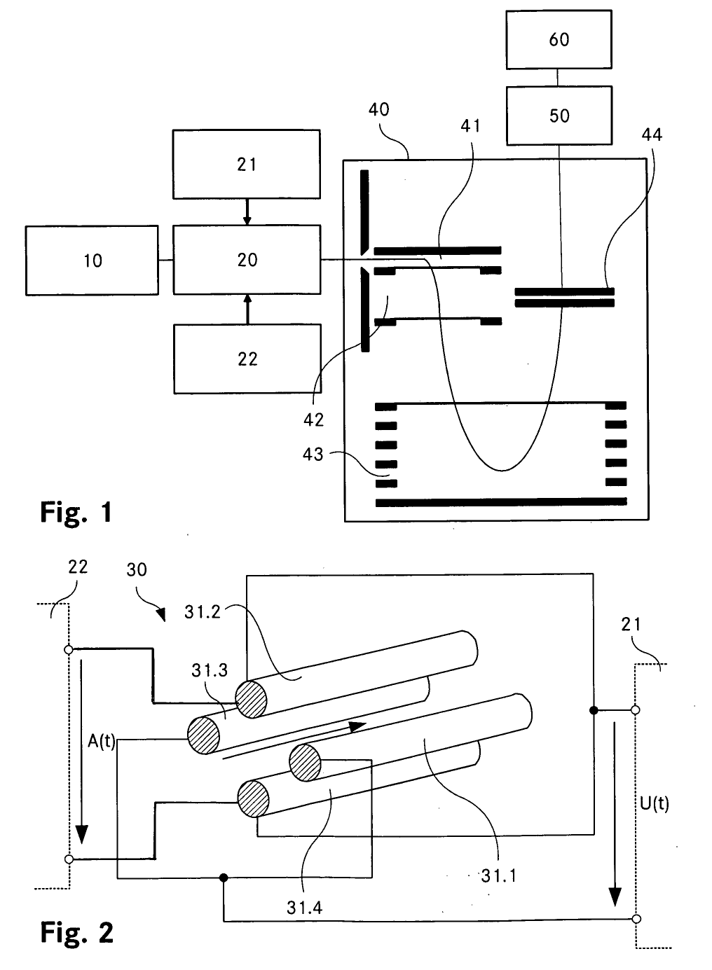

FIG. 1 is a schematic representation of an inventive apparatus for mass analysis of ions. A high current ion source 10 such as an electron impact ion sources generates an ion beam. The output of the high current ion source 10 is about 50 million ions/s. The high current ion source 10 is coupled to a mass filter 20 comprising an RF-only quadrupole ion guide 30, as displayed in FIG. 2. The quadrupole ion guide 30 comprises four rods 31.1 . . . 31.4 arranged parallel to each other, the intersections of the rods 31.1 . . . 31.4 with a plane perpendicular to the rods 31.1 . . . 31.4 constituting a square. Two opposing rods 31.1, 31.3; 31.2, 31.4 each are at the same potential, between neighboring rods 31.1 . . . 31.4 an RF-only voltage

U(t)=V cos(ωt)

is connected, provided by a main RF source 21.

The RF-only quadrupole ion guide 30 is used for elimination of ions belonging to narrow bands of m/q. It is known that an oscillatory inhomogeneous electrical field forms a so-called effective potential which is proportional to E², where E is the amplitude of the electrical field strength oscillations.

In case of a quadrupolar RF electrical field the effective potential results in a net force on the ion towards the quadrupole axis. This force is inverse proportional to the ion mass-to-charge ratio (m/q) and directly proportional to the ion distance from the quadrupole axis. The dynamics of the ion motions are described by the Mathieu differential equations. The fundamental property of the effective potential results in that an ion with a given m/q will perform slow oscillations around the quadrupole axis with a characteristic frequency f₂ which is inversely proportional to its m/q and which relates to the primary RF frequency f_{RF} as:

$${f}_{2} = {q}_{M} \frac{{f}_{R F}}{\sqrt{8}} , where {f}_{RF} = \frac{ω}{2 π} .$$

Since the Mathieu parameter q_{M}<0.906 in the first stability region, this means that the orbiting frequency f₂ is at least roughly 3 times lower than the primary RF frequency f_{RF}. If a second small RF voltage A(t) of this characteristic frequency f₂, provided by an excitation RF source 22 is applied in dipolar (as displayed in FIG. 2) or in quadrupolar mode to the quadrupole rods 31.1 . . . 31.4, the ions with the corresponding m/q will be resonantly excited and finally be ejected from the quadrupole. Ions with different m/q and therefore different characteristic frequencies will not be ejected.

Therefore, the invention consists of a primary RF-only quadrupole field capable of transmitting the mass range of interest. One or several additional RF frequencies with smaller amplitudes are superimposed onto the primary RF field. The frequencies of those additional RF fields must be adjusted to the characteristic oscillation frequencies of the ions to be removed in the primary RF field. Due to these resonant excitations, these ions are then gradually excited by the low amplitude RF fields until they gain enough radial energy to leave the primary RF field. Thereby, these ions are eliminated from entering the following mass analyzer, time-of-flight mass spectrometer (TOFMS) 40.

The TOFMS 40 receives all remaining ions. In an extraction chamber 41 the ions are orthogonally extracted from the primary ion beam into the TOFMS 40. Accelerated by grids 42 the ions traverse the TOFMS 40, passing a reflector 43, and finally hit a detector 44. The detector 44 is connected to data acquisition system 50, which in turn is connected to a computer 60 for further processing of the data.

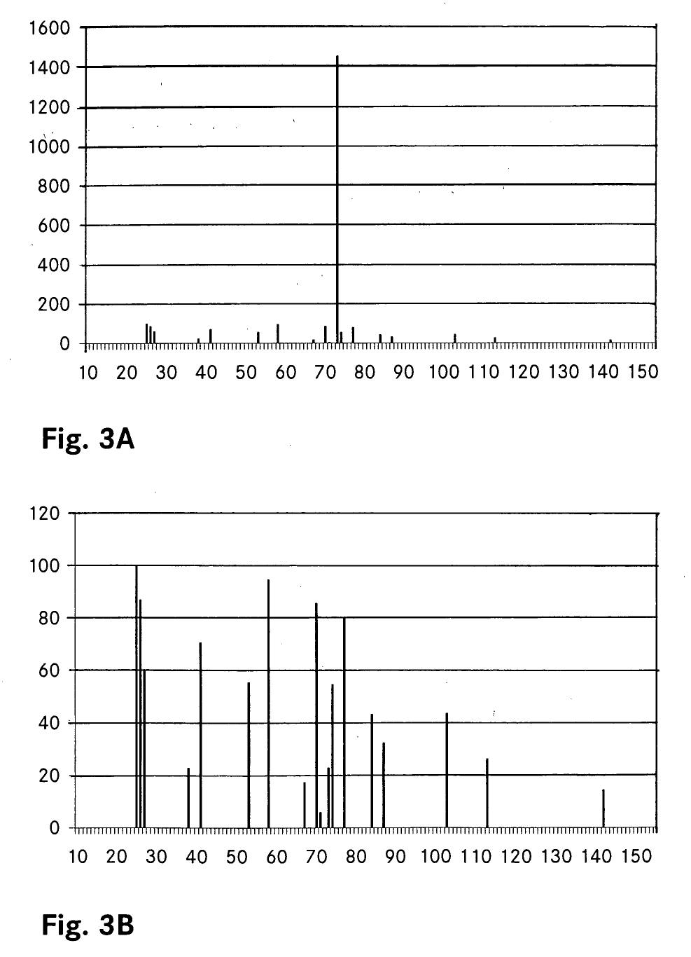

The FIGS. 3A and 3B demonstrate the effect of the inventive mass filtering on a mass spectrum obtained using a downstream TOFMS. As can be seen from FIG. 3A, the spectrum of the ions provided by the high current ion source includes a major ion species, i.e. an ion species of high abundance, having a m/q of about 73 Th. In the given example, about 60% of the detected ions belong to this major species. The large number of ions delivered to the TOFMS lead to saturation of the ion detector and/or the detection electronics. Both these effects as well as peak tails caused by the major species lead to errors in the measurements as well as decreased statistics leading to higher measurement uncertainties.

In FIG. 3B the spectrum as measured by the TOFMS arranged downstream of a mass filter according to the invention is displayed. As can be seen from FIG. 3B the peak at about 73 Th representing the remaining ions measured by the TOFMS is substantially decreased to about 2% of the effective number of ions generated by the high current ion source. Due to this substantial decrease the further ions of different m/q may be more accurately measured and saturation of the ion detector and/or the detection electronics (data acquisition) is avoided.

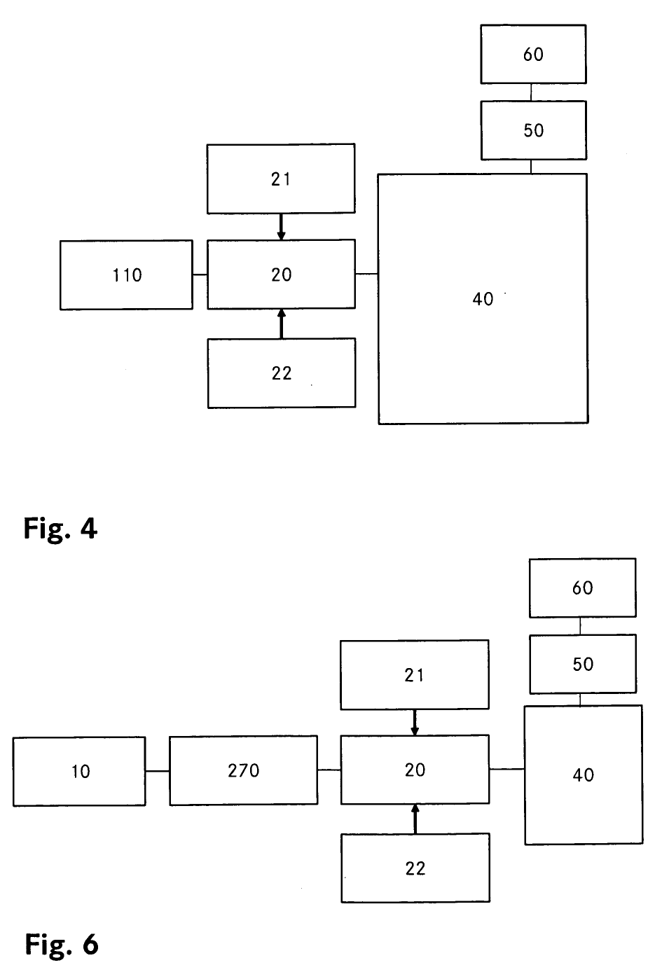

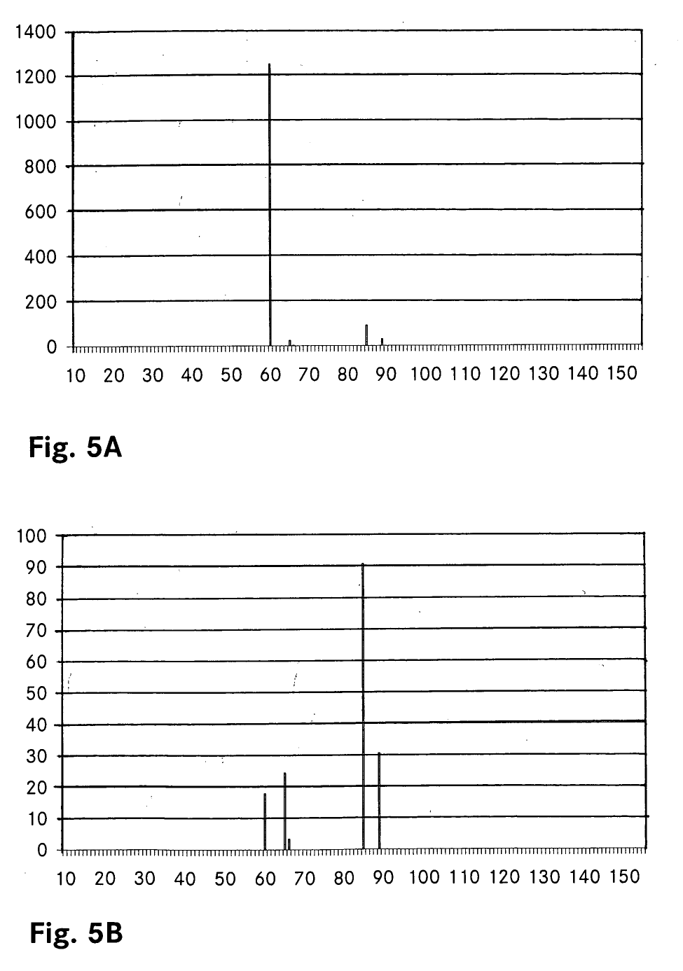

FIG. 4 is a schematic representation of a second inventive apparatus for mass analysis of ions comprising a selective ion source. In many aspects, the apparatus displayed in FIG. 4 corresponds to the apparatus described above in connection with FIG. 1. However, instead of the (broad-band) high current ion source a selective ion source 110 is employed. In the selective ionization process carried out within the selective ion source 110 primary ions are created that subsequently transfer charge to secondary particles to be ionized. As a vast majority of the primary ions reach the TOFMS without having reacted with a secondary particle, the measured spectrum resembles to the spectrum displayed in FIG. 5A. The primary ions, having a mass/charge of 60 Th in the displayed example dominate the mass spectrum. Again, the large number of ions delivered to the TOFMS lead to saturation of the ion detector and/or the detection electronics. Both these effects as well as peak tails caused by the major species lead to increased noise interfering with the measurements as well as decreased statistics leading to higher measurement uncertainties.

Using the mass filter 20 a large percentage of the primary ions may be filtered out before they reach the time-of-flight mass spectrometer (TOFMS) 40. For this purpose the main RF source 21 as well as the excitation RF source 22 are controlled such that RF voltages are generated that lead to elimination of ions having a mass of 60. Accordingly, the TOFMS 40 as well as the data acquisition system 50 and the computer 60 are relieved from analyzing the vast majority of (artifact) ions generated by the selective ion source 110. The corresponding spectrum measured by the TOFMS 40 is displayed in FIG. 5B.

Another inventive apparatus for mass analysis of ions is displayed in FIG. 6. Again, in many aspects this apparatus corresponds to the apparatus described above in connection with FIG. 1. However, a device 270 for cooling the ions generated by the high current ion source 10 is coupled between the high current ion source 10 and the mass filter 20. The device 270 comprises an RF quadrupole ion guide generating a confining quadrupole field capable of transmitting the supplied ions. It holds a gaseous atmosphere filling at least the confining region of the quadrupole field. The pressure of the gaseous atmosphere is about 10 Pa, whereas the same gas is used as in the high current ion source 10. The ions supplied to the device 270 are cooled and thereby an ideal ion phase space is created that allows for substantially lossless injection of the ions into the mass filter 20 as well as transport of the ions through the mass filter 20. The modified phase space provides for an optimum filtering efficiency within the mass filter 20 as well as for improved quality of the measurements taken at the TOFMS 40. Furthermore, the device 270 facilitates the transition of the produced ions from the high current ion source 10 to the low pressure mass filter 20/TOFMS 40.

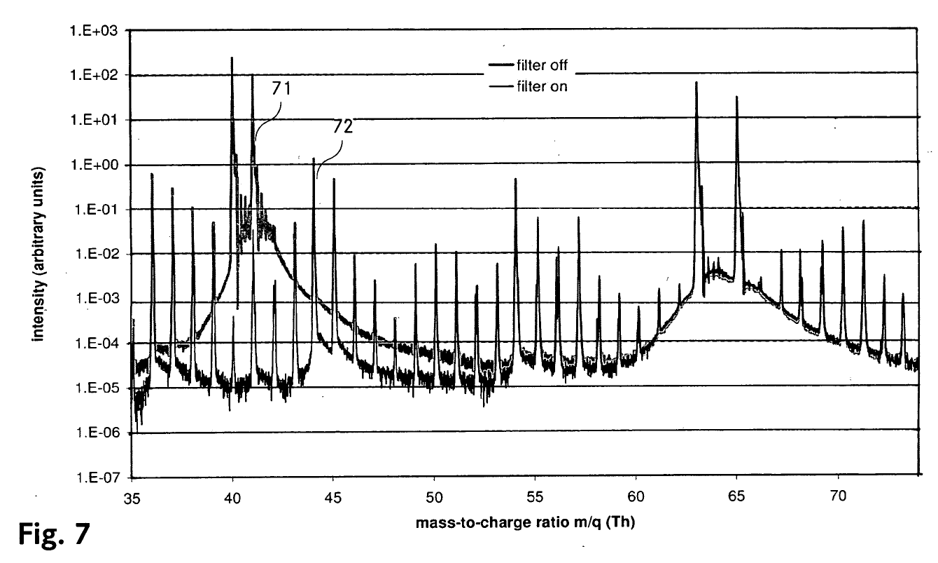

FIG. 7 shows a mass spectrum from a high current ion source recorded without filter (grey line 71). Multiple saturation effects are visible: peak distortions due to DAQ saturation and reflected signals, high background, peak tails. Another mass spectrum of the same source is recorded while filtering the two abundant species at 40 and 41 Th (full line 72). The background is now greatly reduced and the Signal-to-noise ratio of neighboring species is now enhanced up to several orders of magnitude.

Within the context of the invention, it is possible to combine several further RF fields for selectively eliminating several major species that could lead to saturation of the mass analyzer. Alternatively, it is possible to scan through the further RF frequencies. As well it is possible to operate the inventive apparatus in pulsed mode, i.e. to periodically switch the further RF frequency (or frequencies) on and off. This allows for measuring the major as well as the minor species. By adapting the duty cycles and/or amplitudes of the further RF fields the filtering effect may be adjusted if needed. As described above, it is possible not to completely eliminate major species but to suppress them with a suppression factor (which may be determined in a suitable calibration step).

Instead or additionally to the RF-only 2-dimensional quadrupole trapping field other fields may be used such as 3-dimensional fields, higher multipole fields and/or rotating fields. In order to tune the trapping properties of the RF field, an additional DC voltage may be used on the quadrupole rods. The shaping of the RF electrodes may be varied as well, depending on the desired characteristics of the multipole field to be created.

In summary, it is to be noted that the invention creates an apparatus for mass analysis that allows for analyzing minor compound ions generated by a high recurrent ion source with good selectivity, undisturbed by major compounds.

While the method herein described, and the form of apparatus for carrying this method into effect, constitute preferred embodiments of this invention, it is to be understood that the invention is not limited to this precise method and form of apparatus, and that changes may be made in either without departing from the scope of the invention, which is defined in the appended claims.

What is claimed is:

1. An apparatus for mass analysis of ions comprising:
a high current ion source;
a time-of-flight mass spectrometer for analysis of ions transmitted from the high current ion source;
whereas the high current ion source as well as the time-of-flight mass spectrometer are particularly constituted and operated in such a way that a flux of ions generated by the high current ion source causes saturation effects in the time-of-flight mass spectrometer when the high current ion source is directly coupled to the time-of-flight mass spectrometer,
a filter for segmenting incoming ions according to their m/q ratio into a first group of ions and into a second group of ions, whereas the filter is coupled to the high current ion source and whereas the filter and the time-of-flight mass spectrometer are arranged in such a way that the first group of ions are transmitted to the mass spectrometer and that the second group of ions are not transmitted to the mass spectrometer;
whereas
the filter is designed in such a way that the second group of ions consists of ions belonging to one or several narrow bands of m/q.

2. The apparatus as recited in claim 1, wherein the time-of-flight mass spectrometer comprises an ADC ion detection system.

3. The apparatus as recited in claim 1, wherein the filter comprises a field generating device which is designed in such a way that it generates a primary confining field capable of transmitting ions towards the time-of-flight mass spectrometer as well as one or several RF fields superimposed with said primary confining field, whereas these RF frequencies match oscillation frequencies of ions belonging to said one or several narrow bands of m/q such that these ions are resonantly excited and finally ejected from a confining area of the primary confining field.

4. The apparatus as recited in claim 3, wherein the primary confining field is an RF multipole field.

5. The apparatus as recited in claim 4, wherein the primary confining field is an RF-only quadrupole field.

6. The apparatus as recited in claim 5, wherein the RF-only quadrupole field is 2-dimensional and trapping the ions in an area surrounding their main path towards the time-of-flight mass spectrometer.

7. The apparatus as recited in claim 6, wherein the field generating device is capable of generating a rotating quadrupole field.

8. The apparatus as recited in claim 3, wherein the field generating device further generates a coaxial linear field superimposed to the primary confining field in order to transport the incoming ions along an axis of said primary confining field.

9. The apparatus as recited in claim 3, wherein the field generating device is designed in such a way that different superimposed RF frequencies may be alternately generated such that several narrow bands of m/q are scanned and ions belonging to these bands are resonantly excited and ejected from the confining area of the primary confining field.

10. The apparatus as recited in claim 3, wherein the field generating device is designed in such a way that superimposed RF frequencies may be generated that are pulsed with a selectable pulse-width in order to selectively reduce an ion number of at least one of said narrow bands of m/q or in order to subsequently analyze different mass spectra by the time-of-flight mass spectrometer.

11. The apparatus as recited in claim 3, wherein the field generating device is designed in such a way that RF fields may be generated that suppress the second group of ions by a factor pl, where in particular 10⁻⁴<pₗ<0.1.

12. The apparatus as recited in claim 1, wherein a device for cooling the ions to be inserted into the filter, the device being designed in such a way that it generates a confining multipole field capable of transmitting ions towards the filter and that it holds a gaseous atmosphere filling a confining region of the confining multipole field.

13. The apparatus as recited in claim 1, wherein the high current ion source is a selective ion source for selectively ionizing particles to be analyzed and in that the selectively ionized particles are transmitted to the time-of-flight mass spectrometer.

14. A method for mass analysis of ions using in particular an ion source as well as a time-of-flight mass spectrometer that are constituted and operated in such a way that a flux of ions generated by the ion source would cause saturation effects in the time-of-flight mass spectrometer if the ion source were directly coupled to the time-of-flight mass spectrometer, comprising the steps of:
segmenting incoming ions according to their m/q ratio into a first group of ions and into a second group of ions;
transmitting the first group of ions to the time-of-flight mass spectrometer and discarding the second group of ions; and
segmenting the incoming ions in such a way that the second group of ions consists of ions belonging to one or several narrow bands of m/q.

15. The method as recited in claim 14, wherein for segmenting the incoming ions they are injected into a primary confining field capable of transmitting ions towards the time-of-flight mass spectrometer and being superimposed by one or several RF frequencies, whereas these RF frequencies are chosen in such a way as to match oscillation frequencies of ions belonging to said one or several narrow bands of m/q such that these ions are resonantly excited and finally ejected from a confining area of the primary confining field.

16. The method as recited in claim 15, wherein during the segmenting step the ions are subjected to a coaxial linear field superimposed to the primary confining field in order to be transported along an axis of said primary confining field towards the time-of-flight mass spectrometer.

17. The method as recited in claim 15, wherein different superimposed RF frequencies are alternately generated such that several narrow bands of m/q are scanned and ions belonging to these bands are resonantly excited and ejected from the confining area of the primary confining field.

18. The method as recited in claim 15, wherein superimposed RF frequencies are generated that are pulsed with a selectable pulse-width in order to selectively reduce an ion number of at least one of said narrow bands of m/q or in order to subsequently analyze different mass spectra by the time-of-flight mass spectrometer.

19. The method as recited in claim 14, wherein the ions are cooled before the segmenting step by injecting the ions into a gaseous atmosphere, and simultaneously subjecting the ions to a confining multipole field capable of transmitting ions towards a filter.

20. A method for mass analysis of particles, comprising the step of selectively ionizing particles to be analyzed as well as the method as recited in claim 14 for mass analysis of the selectively ionized particles.

21. The method as recited in claim 14, wherein the ions are stored in a confining multipole field, and RF ejection frequencies are applied during part or a total of a storage time of the ions.

22. The method as recited in claim 14, wherein the segmentation of the incoming ions is effected in such a way that the second group of ions are suppressed by a factor pₗ, where in particular 10⁻⁵<pₗ<0.1, and where the method includes a calibration step, during which the factor pₗ is evaluated in order to analyze quantitatively a yield of ions in the second group of ions.

23. The apparatus as recited in claim 1, wherein said high current ion source provides at least 5 million ions/s, preferably at least 50 million ions/s, at an output of said high current ion source.
